(19) United States
(12) Patent Application Publication
(10) Pub. No.: US 2026/0138513 A1
(43) Pub. Date: May 21, 2026

(54) VEHICLE SEAT WITH MOLDED FOAM PART

(71) Applicant: GRAMMER Aktiengesellschaft, Ursensollen (DE)

(72) Inventor: Jörg GIRBINGER, Amberg (DE)

(21) Appl. No.: 19/372,980

(22) Filed: Oct. 29, 2025

(30) Foreign Application Priority Data
Nov. 15, 2024 (DE) 102024133566.1

(51) Int. Cl. B60N 2/70; B60N 2/56; B60N 2/90

(52) U.S. Cl. CPC B60N 2/7035; B60N 2/5642; B60N 2/90

(57) ABSTRACT

A vehicle seat (1) includes a seat part (2) and/or a back part (3). The seat part (2) and/or the back part (3) have a cushion support (12a, 12b) with a cushion (13a, 13b) and a cushion cover (7a, 7b) at least partially enclosing the cushion (13a, 13b). The cushion (13a, 13b) has a recess (9a, 9b) facing a passenger, into which an at least partially plate-like molded foam part (10a, 10b) is inserted essentially parallel to a cushion surface (8a, 8b). The molded foam part (10a, 10b) has a plurality of crests (15) and holes (11) which extend substantially perpendicular to the cushion surface (8a, 8b). The crests (15) are spaced apart from one another, thereby forming channels between the crests (15). At least some holes (11) are arranged in the channels (16), with at least some holes (11) passing through the molded foam part (10a, 10b).

### CROSS-REFERENCE TO RELATED APPLICATIONS

This application claims priority to German Patent Application 102024133566.1 filed on Nov. 15, 2024, the contents of which are incorporated by reference herein in their entirety.

### Technical Field

The invention relates to a vehicle seat with at least one seat part or one back part. The seat or back part has a cushion support with a cushion and a cushion cover that at least partially encloses the cushion. Furthermore, the cushion has a recess facing the passenger, into which an at least partially plate-like molded foam part is inserted essentially parallel to a cushion surface.

### BACKGROUND

Commercial vehicles, such as agricultural machinery, construction machinery, and transport vehicles, are typically used continuously over a long period of time, which is why passengers seating comfort plays a major role. Appropriate vehicle seats are therefore equipped with a variety of comfort features, such as air conditioning systems. These sometimes include a heating system for warming the seat and a ventilation system for cooling the seat. The ventilation system has a fan for generating an air flow and a supply line for supplying the air.

In previous vehicle seats, the seat surfaces and/or backrest surfaces of the seat and/or back part were also provided with an air-permeable spacer fabric so that air could be supplied to the passenger through the seat and/or back part. The spacer fabric was previously inserted into a recess in the seat or backrest cushion. The supply line of the ventilation system also feeds into this recess so that air can be passed through the spacer fabric with the aid of the fan. On the one hand, this spacer fabric is complex and expensive to manufacture, as it must have the same strength properties as the surrounding cushion and also be air permeable. On the other hand, the Air flow passes through the spacer fabric unguided, which is why it exits unevenly from the seat part and/or back part. As a result, areas closer to the inlet of the supply line into the recess are supplied with more air than areas further away.

Consequently, the problem to be solved is to provide a vehicle seat in which the spacer fabric is replaced by a molded foam part that is easier to manufacture, has better cushion properties, and enables improved ventilation through a combination of holes and channels.

### SUMMARY

Therefore, a vehicle seat according to the invention is provided, comprising a seat part and/or a back part, wherein the seat part and/or the back part have a cushion support with a cushion and a cushion cover at least partially enclosing the cushion, and the cushion has a recess facing a passenger. An at least partially plate-like molded foam part is inserted into this recess essentially parallel to a cushion surface. The molded foam part has a plurality of crests and holes extending substantially perpendicular to the cushion surface. The crests are spaced apart from each other, forming channels between the crests. At least some holes are arranged in the channels, with at least some holes passing through the molded foam part.

Usually, the vehicle seat has a vehicle seat base that is bolted to the body of a vehicle, and a vehicle seat superstructure arranged above it. The vehicle seat superstructure comprises the seat part, which extends substantially in a longitudinal direction and a width direction, and the back part, which extends substantially in a width direction and a height direction. The back part is usually arranged so that it can be rotated about the width direction relative to the seat part, so that the angle between the seat part and the back part can be adjusted. Both the seat part and the back part have a supporting structure in the form of a cushion support. The cushion support of the seat part and the back part can be, for example, a seat or backrest shell or a frame structure. The cushion is attached to the cushion support or rests on the cushion support. A recess is arranged in the cushion facing a passenger. The recess can be as deep as the cushion, i.e., it can extend through the entire cushion or only cover part of the depth of the cushion. A molded foam part is inserted into the recess, preferably with an exact fit. This preferably closes flush with the cushion so that there are no uneven areas on the cushion surface due to the inserted molded foam part. The molded foam part can rest directly on the cushion support, the cushion, or an intermediate layer.

According to one embodiment, the side of the molded foam part facing the passenger is smooth, as is customary for foam parts. Alternatively, the surface may also be provided with nubs or similar formations.

According to a particularly preferred embodiment, the crests extend on the underside of the molded foam part in the direction of the cushion support.

The crests ensure that the molded foam part does not lie flat on the cushion or the cushion support or an intermediate layer. In addition, the individual crests are spaced apart from each other. The space between the crests forms channels. Essentially, these run preferably continuously in the longitudinal direction or height direction on the one hand and in the width direction on the other. Deviations in the course may arise due to a special shape or orientation of the molded foam part.

Since the molded foam is usually not air-permeable, the molded foam part is provided with holes that run from the top of the molded foam part to the bottom of the molded foam part. If the back part has the molded foam part, the term “top” should be replaced by “front” and “bottom” by “back.” Everything that applies to the seat part can therefore also apply to the back part, with logical changes to the directional designations not expressly mentioned here.

The holes are preferably arranged in the channels. Alternatively or additionally, holes may also be made in the crests. The crests may have a crown-like shape at their tips, with spaces between the points. Alternatively, the holes may start at the sides of the crests and then run parallel to the direction of the crests through the molded foam part. Preferably, the holes in a molded foam part all run essentially parallel to each other, perpendicular to the surface of the molded foam part, i.e., in the height direction or in the longitudinal direction.

In a particularly preferred embodiment, the crests are arranged in a lattice structure, wherein the lattice corresponds to a quadratic Bravais lattice.

The regular arrangement of the crests enables the channels to run evenly. On the other hand, the deformation behavior under load from a passenger is improved. In addition, the regular formation enables an even air flow through the channels.

According to a particularly preferred embodiment, adjacent rows of crests are arranged offset from each other, with the channels running in a serpentine pattern between the crests.

Preferably, the crests are not arranged exactly at the lattice points but may be slightly offset from them. The crests are offset by less than 30%, preferably less than 25%, and particularly preferably less than 20% of their extent relative to the lattice points. The offset of the individual crests results in the channels formed by the space between the crests running in a serpentine pattern between the channels. Alternatively or additionally, some of the crests can be combined into a base arranged according to a quadratic Bravais lattice.

The serpentine course ensures that the air flow does not flow unhindered through the channels, but is slowed down and deflected by the offset crests. Depending on the curvature of the channels, the air flow is directed through the channels along certain preferred directions. This improves the flow behavior of the air flow, resulting in more even and comfortable ventilation.

In a particularly preferred embodiment, the crests are designed as blunted pyramids, with the base of the crests being rectangular or quadratic.

This blunted pyramid shape improves the stability of the crests under load. In addition, the essentially rectangular or quadratic base area is required for the proper formation of the channels. The air flow is also slowed down by the edges of the crests, which would not be the case with a round base area. The crests are aligned so that they become narrower as they move away from the molded foam part. The bases of two adjacent blunted pyramids are preferably rounded so that the channel between the crests is vaulted.

In a particularly preferred embodiment, the channels run either substantially parallel to a width direction or substantially to a longitudinal direction, with one channel crossing several other channels at crossover points.

According to a particularly preferred embodiment, holes are arranged at the crossover points of the channels.

The arrangement of the holes at the crossover points allows air to pass through the holes from the underside of the molded foam part to the upper side. The serpentine arrangement of the crests causes the air in front of the crests to accumulate at the crossover points of the channels, creating local areas of excess pressure. The holes allow the air to escape additionally.

In a particularly preferred embodiment, the channels between the crests remain intact even when the vehicle seat is loaded by a passenger.

Due to the blunted pyramid shape of the crests, they are compressed under load, so that the channels become smaller, but nevertheless remain intact. This means that the air flow can still flow through the channels even under load, and ventilation of the seat part and/or back part can be achieved.

According to a particularly preferred embodiment, the recess has at least one outlet and/or one inlet for a supply line and/or a discharge line, and the vehicle seat has a pump device, whereby a fluid can be introduced into the recess through the supply line by the pump device and/or the fluid can be discharged from the recess through the discharge line by the pump device.

Starting from the inlet, where the supply line enters the recess, or the outlet, where the discharge line begins to lead out of the recess, a fluid, in particular air, can be supplied to or removed from the recess. Alternatively or additionally, water, either liquid or in the form of water vapor, can also be supplied or removed. The pump device transports the fluid into or out of the recess.

According to a particularly preferred embodiment, the fluid can be conducted through the channels to the holes and through the holes from an underside of the molded foam part to the upper side of the molded foam part or can be discharged in the opposite direction.

Starting from the recess, the fluid or air can flow through the channels to the holes and from there to the top of the molded foam part. Alternatively or additionally, the fluid, for example condensation water, can be removed from the top of the molded foam part through the holes, the channels, and the outlet. According to a preferred embodiment, the pump device can be used both to supply and to remove the fluid. The fluid may also be a combination of several fluids, for example air and water.

### BRIEF DESCRIPTION OF THE DRAWINGS

Further advantageous embodiments are apparent from the following description in conjunction with the drawings. Hereby shows:

FIG. 1 a general view of a vehicle seat;

FIG. 2 a general view of a vehicle seat;

FIG. 3 a side view of a section through a vehicle seat;

FIG. 4 an exploded view of a seat part;

FIG. 5 an exploded view of a back part;

FIG. 6a an isometric view of a molded foam part from below;

FIG. 6b a bottom view of a molded foam part;

FIG. 7a an isometric view of a molded foam part from the rear;

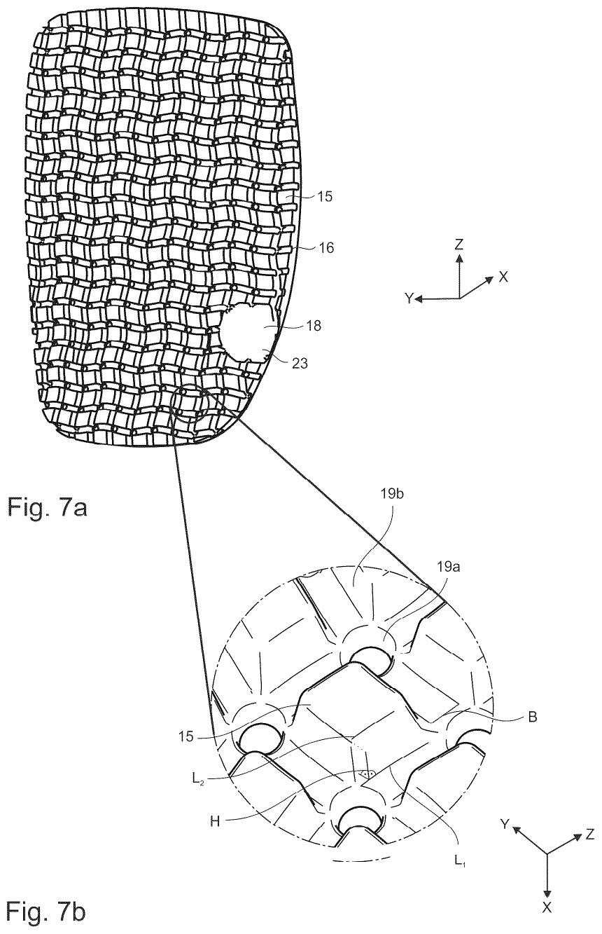

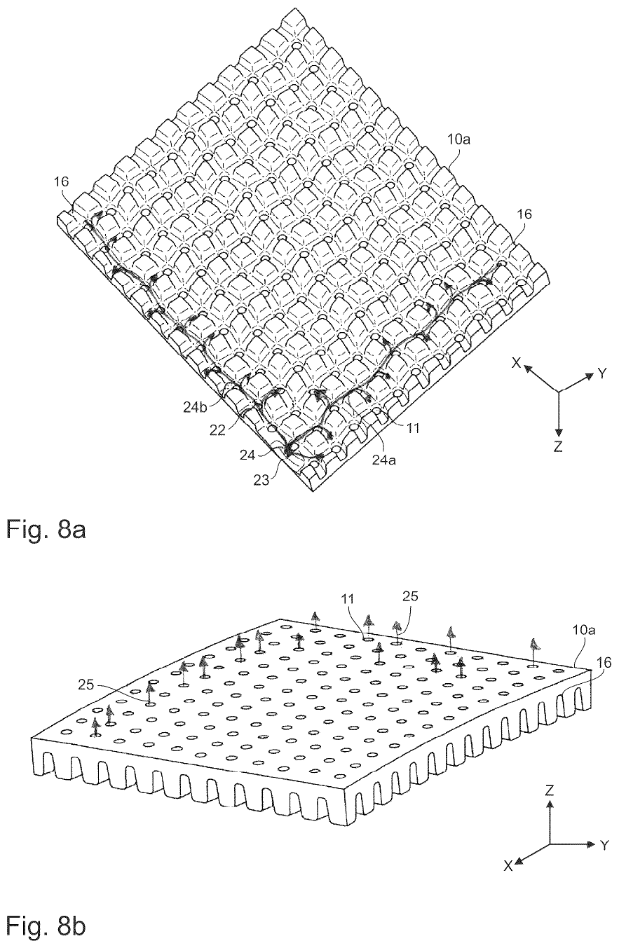

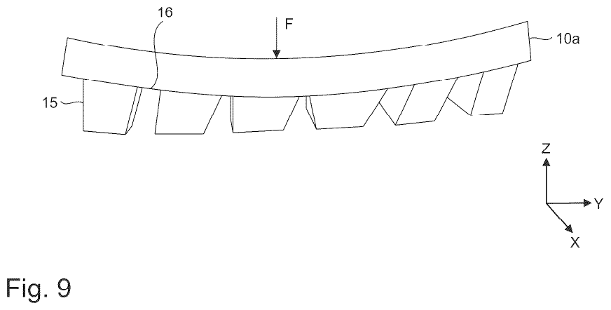

### FIG. 7b an enlarged view of a crest;

FIG. 8a a schematic representation of the air flow through a molded foam part;

FIG. 8b a schematic representation of the air flow through a molded foam part; and

FIG. 9 a perspective view of a molded foam part under load.

For clarity, some reference symbols have been omitted from the figures.

### DETAILED DESCRIPTION

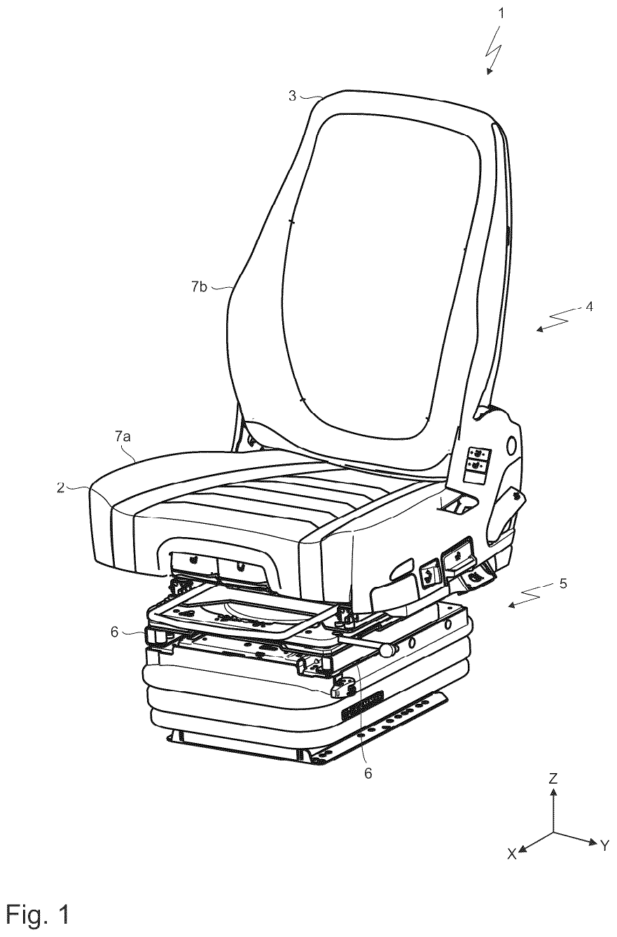

FIG. 1 shows an overall view of a vehicle seat 1 according to the invention. The vehicle seat 1 can be divided into a vehicle seat base 5 and a vehicle seat superstructure 4 arranged above it and supported by it. The vehicle seat superstructure 4 comprises a seat part 2, which extends essentially parallel to the plane from the longitudinal direction X and the width direction Y. A back part 3 is arranged on the seat part 2, which extends essentially in the height direction Z and in the width direction Y. The back part 3 is arranged here almost at right angles to the seat part 2, whereby the angle between the seat part 2 and the back part 3 can be changed by a swivel mechanism. A headrest, not shown here, can also be arranged at the upper end of the back part 3. Attachments such as armrests or consoles, not shown here, can be arranged on the side of the seat part 2 and also on the side of the back part 3. The vehicle seat base 5 is connected to the underside of a vehicle body. In a lower section, the vehicle seat base 5 has a spring device, not shown here, which enables spring movement and height adjustment of the vehicle seat superstructure 4. Two adjustment rails 6 are arranged above the spring device, running in the longitudinal direction X. The seat part 2 or the entire vehicle seat superstructure 4 can be moved in the longitudinal direction relative to the spring device or relative to the part of the vehicle seat base 5 arranged below the adjustment rails by means of the adjustment rails 6.

The seat part 2 is covered with a seat cover 7a, which covers the seat part 2 at least on the upper side. Similarly, the back part 3 is covered with a back cover 7b, which covers the back part 3 at least on the front side, but usually completely.

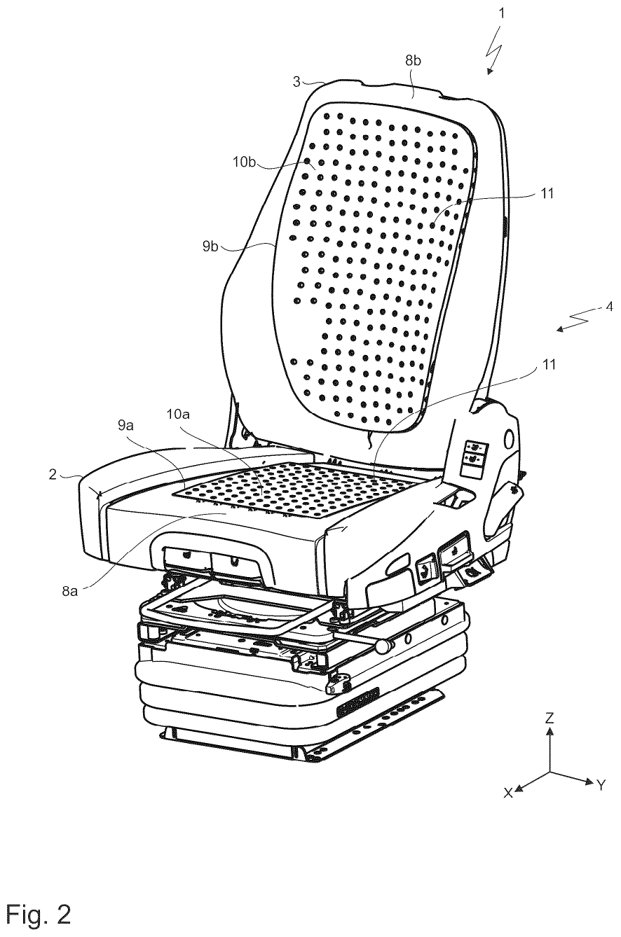

FIG. 2 shows an overall view of a vehicle seat 1 according to the invention, in which the seat cover 7a and the back cover 7b have been removed. In the seat part 2, a recess 9a is provided in the center of a seat surface 8a on which a passenger is in contact with the seat part 2. The recess 9a of the seat part is essentially rectangular in shape. Like the seat part 2, the back part 3 has a recess 9b in the center of a backrest surface 8b, on which the passenger is in contact with the back part 3. The recess 9b of the back part 3 is essentially oval in shape. A molded foam part 10a is arranged in the recess 9a. The molded foam part 10a is exactly fitted into the recess 9a so that the molded foam part 10a and the seat surface 8a are flush. The same applies to the molded foam part 10b, which is arranged in the recess 9b of the back part 3. Holes 11 are provided in the molded foam parts 10a and 10b, which pass through the respective molded foam part. While the holes 11 are arranged regularly for the molded foam part 10a of the seat part 2, the molded foam part 10b of the back part 3 has an area 18 in which no holes 11 are arranged. The arrangement of the holes 11 is adapted to the passengers.

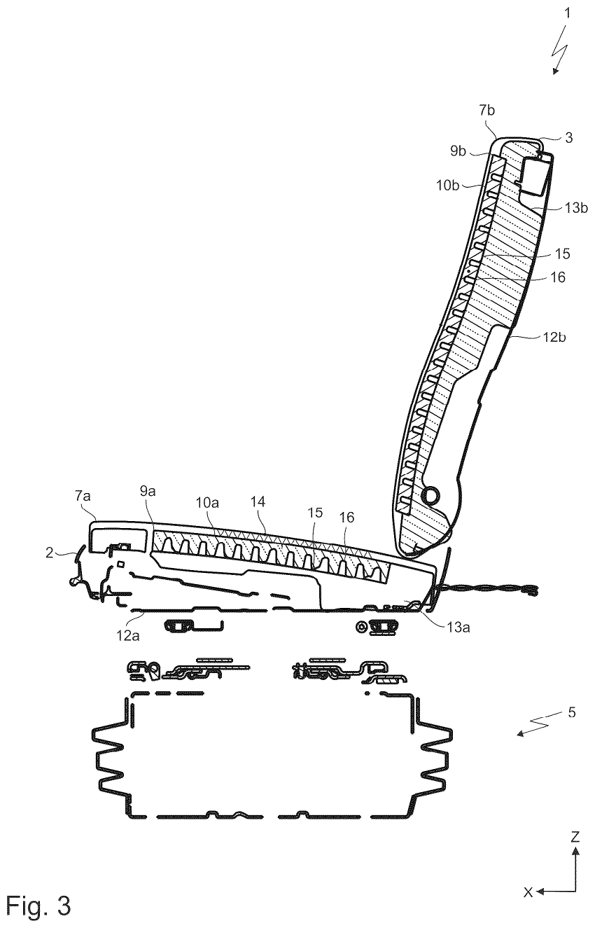

FIG. 3 shows a cross-section of a vehicle seat 1 according to the invention. The seat part 2 is arranged on the vehicle seat base 5. The seat part 2 comprises a cushion support 12a, which is designed as a seat shell 12a. The seat cushion 13a is arranged in the seat shell 12a. The seat cushion 13a has a recess 9a on its upper side. As can be seen, the recess 9a does not extend completely through the seat cushion 13a but is therefore only recessed on the surface. The seat cushion 13a and the molded foam part 10a are covered on the upper side by the cover 7a. The cover 7a has a heating element 14 and a layer of cut foam. The cut foam serves to protect and cover the molded foam part 10a and the cushion part 13a. The seat part 2 can be heated by the heating element 14.

The back part 3 has a cushion support 12b in the form of a backrest shell 12b on the rear side. The back part cushion 13b is inserted into the backrest shell 12b and has the recess 9b on the front side and surface. Analog to the seat part 2, the recess 9b does not pass through the back part cushion 13b. The molded foam part 10b is inserted into the recess 9b and is covered on the front side by the cushion cover 7b. In contrast to the cushion cover 7a of the seat part 2, the cover 7b does not have a heating element.

The molded foam parts 10a and 10b have crests 15 on their underside and rear side, respectively. The crests 15 rest on or are supported by the respective cushion 13a or 13b.

Alternatively, the crests 15 may also be in contact with the cushion support 12a or 12b or an intermediate layer.

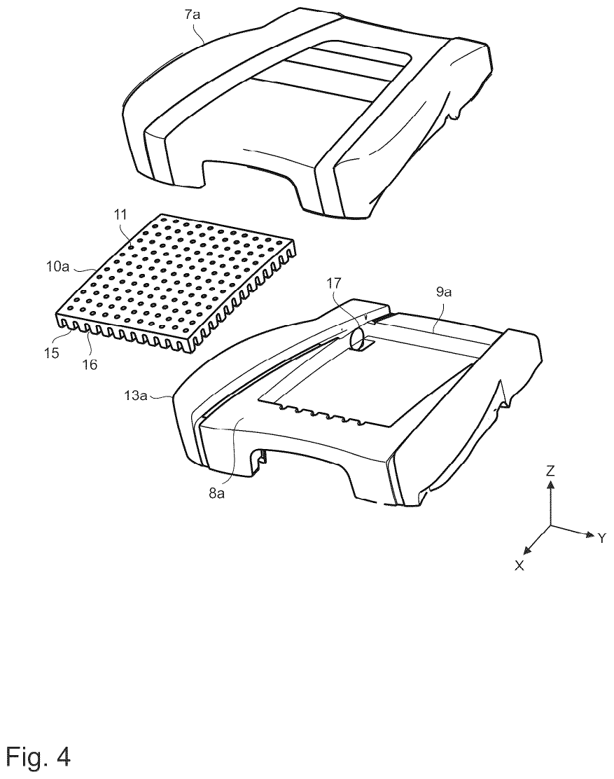

FIG. 4 shows an exploded view of the seat part 2. The rectangular recess 9a is located in the center of the seat cushion 13a. An inlet opening/outlet opening 17 is arranged on one of the sides of the recess 9a. Alternatively, the inlet opening/outlet opening 17 may also be arranged on the underside of the recess 9a in the cushion 13a. The inlet opening/outlet opening 17 is connected to a supply line/discharge line (not shown here) via which air is supplied to the recess 9a and water is discharged from the recess 9a. Alternatively, only one of the two functions can be performed.

As can be seen, the surface 8a of the seat cushion 13a is slightly convex. The molded foam part 10a may also have one or more such contours. In general, however, the molded foam part 10a is sufficiently flexible to adapt to the usual contours defined by the seat cushion 13a or the recess 9a. The seat cover 7a completely covers the molded foam part 10a and the seat cushion 13a, especially on the upper side. The side surfaces of the seat cushion 13a are also covered by the seat cover. Only the underside is not covered by the cover 7a, but the underside of the seat cushion 13a rests on the cushion support 12a.

The molded foam part 10a is designed as a rectangular plate. The molded foam part 10a is also provided with a regular arrangement of holes 11, which are arranged according to a quadratic Bravais lattice. The holes 11 penetrate the molded foam part 10a from the top to the bottom, i.e., they are essentially arranged perpendicular to the surface 8a of the seat cushion 13a. On the underside, the molded foam part has crests 15, which are arranged in the spaces between the holes 11. Channels 16 are formed between the crests 15. Some of the channels 16 run parallel to the longitudinal direction X and others run parallel to the width direction Y. The channels 16 run continuously through the entire molded foam part 10a.

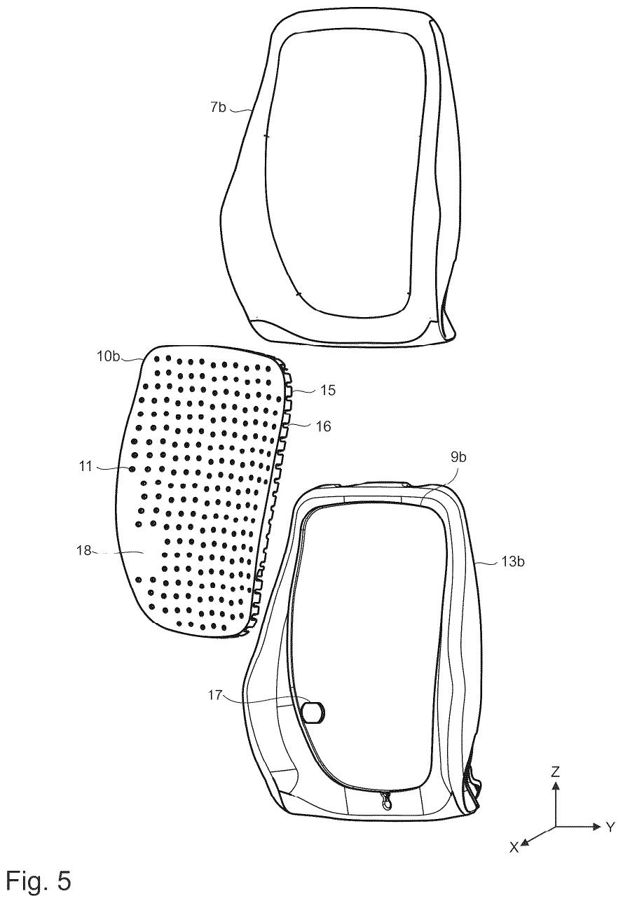

FIG. 5 shows an exploded view of the back part 3. The back part cushion 13b is concave in shape in order to partially enclose the upper body of a passenger. The oval-shaped recess 9b is arranged in the back part cushion 13b. Analog to the seat part 2 in FIG. 4, the back part cushion 13b has an inlet opening/outlet opening 17. However, this is not located in a side surface of the recess 9b, but in the rear surface. Because the inlet opening/outlet opening faces the passenger, the molded foam part 10b has a hole-free area 18. If the area 18 were not designed to be hole-free, the air from the inlet opening/outlet opening would mainly escape locally through the area 18 and would not be distributed over the entire molded foam part 10b.

In contrast to the molded foam part 10a, which is essentially flat on the upper side, the front side of the molded foam part 10b is essentially concave. The rear side provided with the crests 15, is essentially flat, with the exception of the crests 15 themselves. The flat design of the rear side of the molded foam part 10b and, complementing this, the flat design of the recess 9b improve the air flow 24 through the channels of the molded foam part 10b. The cover 7b completely covers the molded foam part 10b and the back part cushion 13b. The cover 7b is tubular in shape and is pulled over the back part cushion support 12b, the back part cushion 13b, and the molded foam part 10b inserted into the recess 9b.

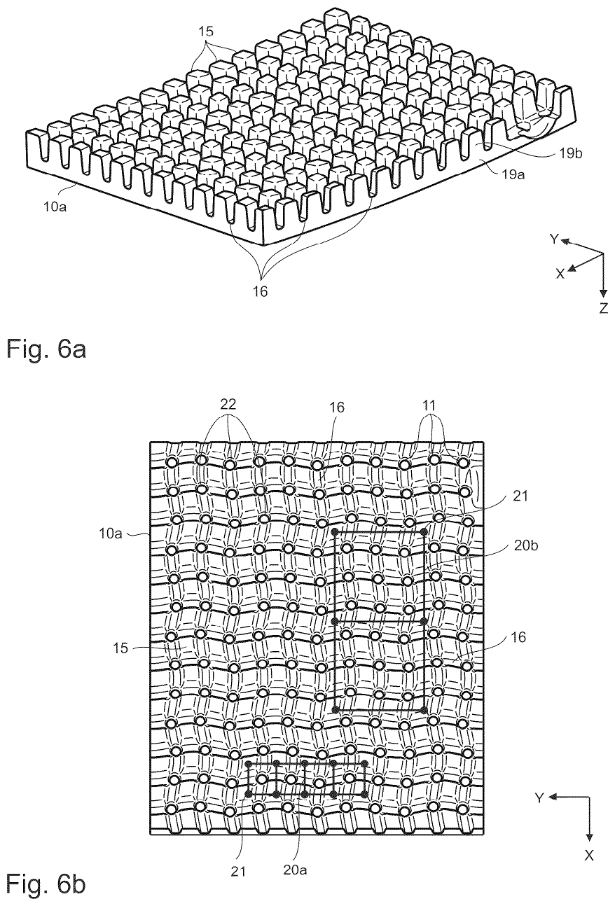

FIG. 6a shows an isometric view of the underside of a molded foam part 10a according to the invention. The molded foam part 10a can be divided into two sections 19a and 19b along the height direction Z. Section 19a is a full foam section that extends across the entire width and length of molded foam part 10a, with the exception of holes 11. The channel section 19b arranged below it in the height direction Z comprises the crests 15 and the channels 16 running between the crests. The channel section 19b serves in particular to distribute the air flow from the inlet opening/outlet opening to the holes 11.

FIG. 6b shows the molded foam part 10a in a bottom view. The Bravais lattice 20 is indicated above some of the crests 15. The crests 15 are essentially located at the lattice points 21 of the Bravais lattice 20. However, it can also be seen that the centers of the crests 15 do not lie exactly on the lattice points 21 but deviate from them. Due to the displacement of the crests 15, the channels 16 formed between the crests 15 are also displaced so that they run in a serpentine pattern. The displacement of the individual crests 15 is again regular and corresponds to a quadratic Bravais lattice. Here, the displacement of the crests 15 repeats every third crest in the longitudinal direction X and the width direction Y. This is shown with the aid of the superordinate Bravais lattice 20b. The crests 15 enclosed between the lattice points 21 of the superordinate Bravais lattice 20b form the basis of the lattice 20b.

The displacement of the lattice points 21 ensures that the crests no longer have a strictly rectangular or quadratic base, but rather a parallelogram-like base. The channels 16 run in a network-like pattern across the entire molded foam part 10a. The channels 16, which run essentially along the width direction Y, intersect the channels 16, which run along the longitudinal direction X, at crossover points 22. The holes 11 are located at these crossover points 22.

FIG. 7a shows a rear view of the molded foam part 10b. The area 18 is free of holes 11, crests 15, and channels 16 and is designed as a full foam section 19a. The area 18 is arranged opposite the inlet opening/outlet opening. Since the area 18 is free of crests 15, the area 18 forms an inlet chamber/outlet chamber 23.

FIG. 7b shows an enlarged isometric view of a crest 15 according to the invention. The crest 15 rises as a blunted pyramid from the full foam section 19a. The blunted pyramid has a quadratic base with a length L₁. Above the base area, at height H, is the quadratic top surface with length L₂. The crest 15 forms a straight blunted pyramid. The ratio of height H to length L₁ to length L₂ is 1:2,5:1,5. In this design, the width B of the channel 16 corresponds to the height H of the crests 15. Preferably, the width B of the channel 16 is less than or equal to the height H of the crests 15. The spaces between the crests 15 are rounded so that the channels 16 run in a vaulted manner between the crests 15.

FIGS. 8a and 8b schematically show the preferred air flow 24 through the molded foam part. Of course, the entire air flow 24 cannot be shown, which is why it is shown schematically using two branches 24a and 24b. Starting from the inlet chamber/outlet chamber 23, into which the air is fed through a supply line, the air flow 24 divides into different branches 24a and 24b. The branches 24a and 24b follow the channels 16 to the next crossover point 22. At the crossover points 22, there are four possible paths for the air flow 24 to take. One is straight ahead, one is to the left, one is to the right, and one is through the hole 11. The serpentine path of the channels results in two preferred directions for the air flow 24. One is the obvious direction straight ahead and the second depends on the displacement of the crests 15. If the channel is curved to the left at crossover point 22 due to the arrangement of the crests 15 (the next row of crests 15 is displaced to the left of the previous row), the air flow 24 is deflected significantly to the right at the crossover point. This means that only a negligible proportion of the air is deflected in the direction in which the channel is curved. Conversely, if the channel is curved to the right at the crossover point 22 (the next row of crests is shifted to the right relative to the previous row), the air flow 24 is deflected significantly to the left at the crossover point 22. When different branches 24a and 24b of the air flows 24 meet, congestion zones are created in which the air flow preferentially escapes through the holes 11. Compared to straight channels, this improves the steering of the air flow 24 by the molded foam part 10a.

In FIG. 8b, the air outlet 25 is indicated by a few holes 11. The air from the channels 16

flows preferentially through these from the bottom to the top. The serpentine shape of the channels 16 increases the number of holes 11 through which the air flows preferentially and homogenizes the flow rate through the holes 11, i.e., the air flows more evenly. Analog to the representation in FIGS. 8a and 8b, the air flow 24 can of course also flow in the opposite direction and the inlet chamber 23 can be used as an outlet chamber 23. A temporary alternation or reversal of the flow directions of the air flow 24, caused by the passenger or a vehicle control system, is also provided for. In this case, the direction of rotation of a pump not shown here is preferably reversed.

FIG. 9 shows the molded foam part in a perspective view under load. The force F represents a passenger who has taken a seat in a vehicle seat 1 and is exerting load on the molded foam part 10a or 10b. Usually, the load F on a molded foam part 10a in the seat part 2 is greater than on a molded foam part 10b in the back part 3. Under the load F, the crests 15 deform in particular in such a way that they are compressed along the height direction Z. This causes the channels 16 to become smaller in the height direction Z on the one hand and, depending on the course of the channel 16, in the longitudinal direction X or in the width direction Y on the other hand. However, the blunted pyramid shape of the crests ensures that as long as the crests 15 are not completely compressed, the channels 16 remain intact so that the air flow 24 can flow through the channels. In addition, the vaulted shape of the channels improves the stability of the molded foam parts 10a, 10b and reduces deformation of the molded foam parts 10a, 10b under load F.

### Reference List

1 Vehicle seat
2 Seat part
3 Back part
4 Vehicle seat superstructure
5 Vehicle seat base
6 Adjustment rail
7a Seat cover
7b Back cover
8a Seat surface
8b Backrest surface
9a Recess in seat part
9b Recess in back part
10a Molded foam part in seat part
10b Molded foam part in back part
11 Holes
12a Cushion support of the seat part
12b Cushion support of the back part
13a Cushion of the seat part
13b Cushion in the back part
14 Heating element
15 Crest
16 Channel
17 Inlet opening/outlet opening
18 Area
19a Full foam section
19b Channel section
20a Bravais lattice
20b Superordinate Bravais lattice
21 Lattice point
22 Crossover points
23 Inlet chamber/outlet chamber
24 Air flow
24a First branch of the air flow
24b Second branch of the air flow
25 Air outlet
H Height of a crest
L Length of the base area of a crest
L2 Length of the top area of a crest
B Width of a channel
F Force
X Longitudinal direction
Y Width direction
Z Height direction

1. Vehicle seat (1) comprising a seat part (2) and/or a back part (3), wherein the seat part (2) and/or the back part (3) comprise a cushion support (12a, 12b) with a cushion (13a, 13b) and a cushion cover (7a, 7b) at least partially enclosing the cushion (13a, 13b), the cushion (13a, 13b) has a recess (9a, 9b) facing a passenger, into which an at least partially plate-like molded foam part (10a, 10b) is inserted essentially parallel to a cushion surface (8a, 8b),
wherein
the molded foam part (10a, 10b) has a plurality of crests (15) and holes (11) extending substantially perpendicular to the cushion surface (8a, 8b), the crests (15) being spaced apart from one another, whereby channels are formed between the crests (15), at least some holes (11) being arranged in the channels (16), at least some holes (11) passing through the molded foam part (10a, 10b).

2. Vehicle seat (1) according to claim 1,
wherein
the crests (15) extend on the underside of the molded foam part (10a, 10b) in the direction of the cushion support (12a, 12b).

3. Vehicle seat (1) according to claim 2,
wherein
the crests (15) are arranged in a lattice structure (20a, 20b), wherein the lattice (20a, 20b) corresponds to a quadratic Bravais lattice.

4. Vehicle seat (1) according to claim 3,
wherein
adjacent rows of crests (15) are arranged offset relative to one another, wherein the channels (16) run in a serpentine manner between the crests (15).

5. Vehicle seat (1) according to claim 1, wherein
the crests (15) are designed as blunted pyramids, wherein the base area of the crests (15) is rectangular or quadratic.

6. Vehicle seat (1) according to claim 1, wherein
the channels (16) run either substantially parallel to a width direction (Y) or substantially parallel to a longitudinal direction (X), wherein one channel (16) crosses several other channels (16) at crossover points (22).

7. Vehicle seat (1) according to claim 6, wherein holes (11) are arranged at the crossover points (22) of the channels (16).

8. Vehicle seat (1) according to claim 1, wherein
the channels (16) between the crests (15) are retained even when the vehicle seat (1) is loaded by a passenger.

9. Vehicle seat (1) according to claim 1, wherein
the recess (9a, 9b) has at least one outlet opening (17) and/or one inlet opening (17) of a supply line and/or a discharge line, and the vehicle seat (1) has a pump device, wherein a fluid can be introduced into the recess (9a, 9b) through the pump device and/or the fluid can be discharged from the recess (9a, 9b) through the discharge line by the pump device.

10. Vehicle seat (1) according to claim 9, wherein
the fluid can be conducted through the channels (16) to the holes (11) and through the holes (11) from an underside of the molded foam part (10a, 10b) to the upper side of the molded foam part (10a, 10b), or can be discharged in the opposite direction.
